(19) United States
(12) Patent Application Publication
(10) Pub. No.: US 2017/0305132 A1
(43) Pub. Date: Oct. 26, 2017

(54) Adhering Two Substrates Using Latent-Reactive Adhesive Films

(71) Applicant: TESA SE, Norderstedt (DE)

(72) Inventors: Thilo DOLLASE, Hamburg (DE); Matthias KOOP, Norderstedt (DE); Sven REITER, Hamburg (DE); Daniel SCHMITZ-STAPELA, Hamburg (DE); Susanne KATZ, Hamburg (DE); Jerome STOLTZE, Hamburg (DE)

(21) Appl. No.: 15/521,546

(22) PCT Filed: Oct. 15, 2015
(86) PCT No.: PCT/EP2015/073935

§ 371 Date: Apr. 24, 2017

(30) Foreign Application Priority Data
Oct. 31, 2014 (DE) 10 2014 222 259.1

(51) Int. Cl. B32B 37/12; C09J 7/02; C09J 5/02; B32B 7/12; C08K 9/10; B32B 37/06; C09J 175/04; C09J 5/06

(52) U.S. Cl. CPC B32B 37/1207; C09J 175/04; C09J 7/02; C09J 5/06; B32B 7/12; C08K 9/10; B32B 37/06; C09J 5/02

(57) ABSTRACT

The invention relates to a method for adhering two substrates, namely a first substrate A and a second substrate B, to each other using a latent-reactive adhesive film with at least one latent-reactive adhesive film layer which has a thermoplastic component with a melting temperature T(melt), where 35° C.≦T(melt)≦90° C., said thermoplastic component containing functional groups that can react to isocyanate, and an isocyanate-containing component that is dispersed into the thermoplastic component in a particulate form and is blocked, microencapsulated, or substantially deactivated in the region of the particle surface. The particles have a start temperature T(start) of 40° C.≦T(start)≦120° C., wherein T(start)≧T(melt). A surface of the first substrate A is brought into contact with a first surface of the latent-reactive adhesive film, and a surface of the second substrate B is brought into contact with the second surface of the latent-reactive adhesive film. The adhesion is caused by heating the latent-reactive adhesive film to a temperature which corresponds to or is higher than at least the start temperature T(start). The invention is characterized in that at least the surface of the first substrate A which is brought into contact with the latent-reactive adhesive film is treated with a primer before the first substrate A is brought into contact with the latent-reactive adhesive film, and/or at least the first surface of the latent-reactive adhesive film which is brought into contact with the first substrate A is treated with a primer before the first substrate A is brought into contact with the latent-reactive adhesive film.

This is an application filed under 35 USC 371 based on PCT/EP2015/073935, filed 15 Oct. 2015, which in turn is based on DE 10 2014 222 259.1 filed 31 Oct. 2014. The applicant claims the entire available priority benefits to these two prior applications, and incorporates them in their entirety herein.

This is an application filed under 35 USC 371 based on PCT/EP2015/073935, filed 15 Oct. 2015, which in turn is based on DE 10 2014 222 259.1 filed 31 Oct. 2014. The applicant claims the entire available priority benefits to these two prior applications, and incorporates them in their entirety herein.

The invention relates to an assembly of two substrates, more particularly substrates of which at least one has inorganic (hydrophilic) character on the side to be bonded, these substrates being bonded by means of a latent-reactive adhesive film, said assembly being intended more particularly for use for optical, electronic and/or precision-mechanical devices. By means of a primer which is applied on that side of the substrate with inorganic character that is to be bonded, the assembly strength under heat/humidity conditions can be improved. The invention relates, furthermore, to a method for producing such assemblies.

Virtually all devices in modern consumer electronics have visual display systems for displaying the operating status of the device, or other information. Where more complex relationships require representation, the display function is frequently realized using display modules based on liquid crystals (LCD) or on organic light-emitting diodes (OLED). Such displays are employed, for instance, in digital cameras, portable microcomputers, and mobile telephones. To protect the display modules from any damage from external mechanical effects such as, for example, shocks, such display systems typically have transparent protective windows which cover the outside of the display modules and so reduce the risk of direct exposure of the module. Such protection is likewise required in nonelectronic visual display systems, such as with mechanical displays such as timepieces or level indicators on storage vessels, for example. Glass is commonly used for protective windows, owing to the advantages it offers on the basis of its tactile qualities relative to plastics. Glass, moreover, is inert to all organic solvents and, in view of its high hardness, is also scratch-resistant, thus conveying a high-quality impression. Sheets of glass are also employed when there are optical functions to be fulfilled, such as refraction, focusing, attenuation or amplification of light. When lenses of this kind are installed into the mount or the device body, the requirements are similar to those for the above-described windows.

A form of adhering which has been increasingly in demand in recent years, particularly in the electronics sector, as for example in mobile telephones or laptop computers, is the bonding of anodized aluminum. Anodized aluminum is becoming ever more significant as decorative material in electronic devices. Anodized or else so-called “eloxed” aluminum, i.e., aluminum processed by the Eloxal process, is aluminum on whose surface an oxidic protective layer has been formed by anodic oxidation of the aluminum. In this case, in contrast to the processes of coating by electroplating, the protective layer is not deposited on the workpiece; instead, an oxide or hydroxide is formed by conversion of the uppermost metal layer. This protective layer therefore has a particularly good bond to the aluminum. A layer is formed which is 5 to 25 μm thick and which protects lower-lying layers from corrosion as long as no gaps are formed in this layer, as a result of mechanical damage, for example.

The bonding of various substrates in electronic devices, especially small portable devices such as mobile telephones and the like, is nowadays accomplished primarily by means of double-sided self-adhesive tapes.

In modern consumer electronics devices, and also in other mobile devices, there are often various components which must be bonded to one another, in some cases with only very low border widths. By “border” or “border width” is meant in this context the configuration of a double-sidedly bonding material. Instead of a full-area bond, the desire is often only for framelike bonding. The adhesive system in such a scenario is employed in the form of a ready-made section which may have a segment (“border”) of low width (“border width”). These border widths in at least one section of the bonding region may be not more than 2 mm, not more than 1 mm, not more than 0.8 mm, or even around 0.5 mm. At such widths, the bonding strengths of self-adhesive tapes are often inadequate, and so in these cases it is frequently necessary to fall back to using liquid reactive adhesives. The use of liquid adhesives, however, carries with it certain disadvantages, being associated with considerable odor nuisance. Moreover, liquid adhesives are awkward to handle. The search is therefore on for adhesive systems which have a low vapor pressure and are available for relatively clean processing in sheetlike form. Heat-activatable films are appropriate for this purpose. Since even heat-sensitive substrates are to be bonded to one another, the demand is for heat-activatable films which can be processed even at very low temperatures (T not more than 120° C. or even not more than 100° C.). Examples of particularly heat-sensitive substrates, which do not tolerate processing temperatures of much above 100° C., are anodized (eloxed) aluminum, various (transparent) plastics, and some surface-modified components.

The skilled person is therefore interested in suitable and ever-improved adhesive systems for double-sided adhesive films for the bonding, for example, of such cover glasses or lenses to mounts or housings. The profile of requirements for adhesive systems in these applications includes a high push-out strength (that is, the bonding strength of the component in its mount) and often also at the same time high impact strength even at low temperatures, so that individual components do not break apart at the bonded joint if dropped. In terms of the bonding strength, adhesive systems comprising a layer of a latent-reactive adhesive film appear highly suitable. Examples of latent-reactive adhesive films can be found in Habenicht (G. Habenicht, Kleben, 6th edn., 2009, J. Springer, Heidelberg, pp. 242-243). Typical of such systems is the existence of a reactive system within a film, in which the reaction partners are present effectively separated from one another below the processing conditions (that is, usually, at reduced temperature), or one of the reaction partners is otherwise inhibited in its reactivity, thereby suppressing reaction/curing under these conditions. Many such latent-reactive adhesive films, as for example those based on epoxide/dicyandiamide (B. Müller, W. Rath, Formulierung von Kleb- und Dichtstoffen, 2nd edn., 2009, Vinzentz Network, Hannover, pp. 167-169), nevertheless require temperatures for curing that are too high for sensitive components. Only specialty reactive systems, therefore, can be employed for the adhesive bonding of sensitive components.

Adhesive products presenting as advantageous for high bonding strengths at low bonding temperatures are those having at least one layer of a latent-reactive adhesive film which comprises a thermoplastic component, which contains functional groups which are able to react with isocyanate, and an isocyanate-containing component, which is present in particulate form in dispersion in the thermoplastic component and is blocked (see, for example, B. Müller, W. Rath, Formulierung von Kleb- and Dichtstoffen, 2nd edn., 2009, Vinzentz Network, Hannover, pp. 141-144 as technological illustration material), microencapsulated (see, for example, U.S. Pat. No. 4,483,744 and J.-M. Pernot, B. Pouyet, H. Brun, S. Briancon in Microspheres, Microcapsules & Liposomes, Vol. 1, R. Arshady (ed.), Citus Books, London, pp. 441-456 as technological illustration material), or substantially deactivated in the region of the particle surface (see, for example, WO 99/29755 as technological illustration material), and which is generated from aqueous dispersion.

WO 93/25599 A1 discloses formulations for latent-reactive polyurethane systems, comprising deactivated polyisocyanates, which exhibit reactivity at temperatures above 55° C., and polymers which at temperatures above 40° C. are meltable and are able to react with isocyanate. These formulations can be coated onto substrates, which can then be bonded. Subjecting substrates to be bonded to pretreatment with a primer is not described.

DE 10 2010 013 145 A1 describes adhesive compositions which are heat-activatable and have latent reactivity. At room temperature they have slight pressure-sensitive tack, and, after initial heating and cooling, still have tack for a certain time. These adhesive compositions are based preferably on polyurethanes. Subjecting substrates to be bonded to pretreatment with a primer is not described.

WO 99/29755 describes reactive polyurethane adhesive systems based on aqueous polyurethane dispersions. The matrix of a thermoplastic polyurethane which still carries functional groups for reaction of isocyanates has, dispersed therein, polyisocyanate particles which are deactivated on their surface. At a first temperature, the thermoplastic polyurethane melts. At a higher temperature, the deactivated particle surface breaks down and the isocyanate groups are able to react with the functional groups of the thermoplastic polyurethane. Possible ingredients of the formulations include silanes. Using silanes in the function of an adhesion promoter in this way, however, carries with it the disadvantage that silanes in an aqueous medium may undergo hydrolysis and condensation, meaning that their interfacial activity may be reduced. Moreover, their mode of action may be adversely affected by possible further ingredients of the dispersion such as stabilizers and measures taken to set a pH which is important for the stability of the dispersion. Incorporating an active substance such as a silane into the adhesive formulation itself, moreover, necessitates a relatively high quantity of the active substance used, since the major part thereof remains in the volume of the adhesive layer and is not active at the target surface. Subjecting substrates that are to be bonded to pretreatment with a primer, and the associated effects, are not described in WO 99/29755.

U.S. Pat. No. 6,797,764 B2 describes aqueous adhesive formulations based on polyurethane. These formulations may comprise adhesion promoters such as silanes. Examples given of materials to be bonded, in addition to plastics, include stainless steel, aluminum, copper, iron, cold-rolled steel, and phosphatized steel. Applications for electronic and mobile devices are not stated. The adhesive compositions, moreover, have no latent reactivity.

WO 00/34403 A1 describes aqueous, polyurethane-based adhesive formulations for the bonding of rubber articles. The rubber articles may have been pretreated with a primer. The disclosure teaches that the hydrolysis resistance of polyester groups can be improved by addition of epoxides. Responsibility for unwanted hydrolysis is attributed to chemical degradation products of the primer. Applications for electronic and mobile devices are not stated. The adhesive compositions, moreover, have no latent reactivity. In this specific case, the specified combination of polyurethane-based adhesive and primer appears to be detrimental to the stability of the bonded assembly.

WO 2013/127697 A1 relates to the adhesive bonding of anodized aluminum to a plastic by means of a polyurethane-based, latent-reactive adhesive film. Plastics materials may be surface-modified and carry inorganic layers. Glasses and other metals as materials to be bonded are not stated. Subjecting substrates to be bonded to pretreatment by means of a primer is not specified.

The effect of coupling agents such as silanes as adhesion promoters in fundamental terms is described in the literature by, for example, Plueddemann (E. P. Plueddemann in “Fundamentals of Adhesion”, L. H. Lee (ed.), Plenum Press, New York, 1991). In this sense, adhesion promoters/primers may be understood as means for increasing adhesion/bonding strength, but not as means for preserving an existing bonding strength in the face of external influences. Specific further advantageous utilization per se and in relation to specific combinations of adhesive film, substrate, and primer are not specified.

DE 10 2007 030 196 A1 and DE 10 2009 007 930 A1 describe silane solutions for pretreating a hydrophilic surface to render it water-repellant for improving the adhesion of pressure-sensitive adhesive layers. The utilization of latent-reactive adhesive films for the bonding of substrates with inorganic character is not specified. Nor is there any description to the effect that the bonding strength under heat and humidity influence can be improved, for the specific case of electronic or mobile devices, through use of a primer.

A central requirement of devices in modern consumer electronics, and of other mobile devices, however, is the stability under hot/humid conditions. Thus assembly strengths for bonded substrates are determined before and after hot/humid storage, and their strengths are compared. Too sharp a drop in the bond strength under these conditions is undesirable. The bond strength of inorganic (hydrophilic) surfaces with a polyurethane-based, latent-reactive adhesive film is affected by exposure to hot, humid conditions. The object is therefore to provide an assembly comprising at least one substrate which, on the side to be bonded, has inorganic (hydrophilic) character (glass, ceramic, metal, and correspondingly inorganically (hydrophilically) coated materials, which themselves may be organic in nature), and comprising a latent-reactive adhesive film which is rapidly curable in a hot press at relatively low temperatures, so that the bond strength of the assembly is affected to less of an extent, or not at all, by exposure to hot, humid conditions. For electronic devices and other mobile devices, moreover, the adhesive bonds are required to be shock-resistant.

### Invention

It has been found that the object according to the invention can be achieved if, in the adhering of substrates, particularly with inorganic surfaces, the contact areas are primed, which come about in the course of bonding as a result of the substrate surface, more particularly the inorganic substrate surface, and the surface of the latent-reactive adhesive film. Priming of the contact area refers to the priming of the corresponding substrate surface or of the corresponding adhesive-film surface, or of both surfaces. Where two substrates are bonded to one another by means of the latent-reactive adhesive film, priming ought advantageously to be carried out at least on the contact area formed by the inorganic surface and the adhesive film. Where the surfaces of both substrates are inorganic, it is advantageous in accordance with the invention to prime at least one of the contact areas—substrate area, adhesive-film area, or substrate area and adhesive-film area—with preference both contact areas are primed.

The invention relates in particular to a method for adhering two substrates, namely a first substrate A and a second substrate B, to one another, by means of a latent-reactive adhesive film having at least one latent-reactive adhesive film layer which contains a thermoplastic component, which has a melting temperature T(melt) where 35° C.≦T(melt)≦90° C. and contains functional groups which are able to react with isocyanate, and an isocyanate-containing component, which is present in a particulate form incorporated by dispersion into the thermoplastic component and which is blocked, microencapsulated, or substantially deactivated in the region of the particle surface, where the particles have an onset temperature T(onset) of 40° C.≦T(onset)≦120° C. and where T(onset)≧T(melt), where a surface of the first substrate A is contacted with a first surface of the latent-reactive adhesive film, and where a surface of the second substrate B is contacted with the second surface of the latent-reactive adhesive film, where the adhering is effected by heating of the latent-reactive adhesive film to a temperature which at least corresponds to the onset temperature T(onset) or is higher, where, furthermore, at least the surface of the first substrate A that is contacted with the latent-reactive adhesive film is treated with a primer before the first substrate A is contacted with the latent-reactive adhesive film, and/or at least the first surface of the latent-reactive adhesive film which is contacted with the first substrate A is treated with a primer before the first substrate A is contacted with the latent-reactive adhesive film.

For the purposes of this description, T(melt) is the melting temperature of the thermoplastic component, and T(onset) is the temperature at which the isocyanate groups of the particles incorporated by dispersion into the thermoplastic component are enabled to react with the functional groups of the thermoplastic polyurethane (for example, because they are distributed in the matrix with the thermoplastic polyurethane). In the case of blocked isocyanate groups, T(onset) is linked to the deblocking temperature; in the case of microencapsulation, it is linked to the release of isocyanate from the microcapsules (for example, through melting of the microcapsule shell); and, in the case of the isocyanates deactivated in the region of the surface of the isocyanate particles, it is associated with melting of the isocyanate particles. For the purposes of this invention, systems which are conceivable are all isocyanate-containing systems known from the prior art and being blocked, microencapsulated, and/or deactivated in the region of the particle surface, and also meeting the specifications for T(onset). The thermoplastic polyurethanes and the isocyanate-containing component are preferably dispersible or in dispersion in an aqueous medium.

Melting temperatures are determined by means of differential scanning calorimetry (DSC) according to DIN 53765-B-10 (1994).

T(onset) is likewise determined by means of differential scanning calorimetry (DSC). The signal evaluated in this case is the exothermic signal in the thermogram of the first heating curve at a heating rate of 10 K/min, corresponding to the reaction of the isocyanate groups. The T(onset) used is the onset temperature of this signal.

Here, in particular, at least the surface of the first substrate A that is contacted with a first surface of the latent-reactive adhesive film is formed wholly or partly, more particularly at least predominantly, of an inorganic material. The surface of the second substrate that is to be bonded may also be wholly or partly—more particularly predominantly—inorganic. In that case it is particularly preferred if both contact areas are primed.

It is therefore optionally advantageous if the surface of the second substrate B that is contacted with the latent-reactive adhesive film is also treated with a primer before the second substrate B is contacted with the latent-reactive adhesive film, and/or if the second surface of the latent-reactive adhesive film that is contacted with the second substrate B is also treated with a primer before the second substrate B is contacted with the latent-reactive adhesive film, and, specifically, it is especially advantageous when the surface of the second substrate B that is contacted with the latent-reactive adhesive film is also wholly or partly inorganic.

The heating of the latent-reactive adhesive film to the temperature which corresponds at least to the onset temperature T(onset) or is higher is accomplished preferably in relation to a preliminary assembly, produced from the substrate A and the adhesive film, or to a preliminary assembly made from the substrate A, the adhesive film, and the substrate B. For these purposes, the corresponding substrate areas and adhesive-film areas as represented above are brought into contact; optionally, the contact area formed from the surface of the substrate A with the adhesive-film surface, and/or the contact areas formed from the surface of the substrate B with the adhesive-film surface, can also be subjected to preliminary fixing, by means, for instance, of thermal lamination (in the case of double-sided thermal lamination, carried out simultaneously or successively), introduction of heat to one or both contact areas (in the latter case, simultaneously or nonsimultaneously), or the like. Any heat introduced for preliminary fixing ought here in each case to be below the onset temperature of the latent-reactive adhesive film by a margin such that there is as yet no onset (no initiation) of the ultimate bonding—the bonding brought about by the reaction of the isocyanate with the functional groups of the thermoplastic component.

The invention also provides an assembly comprising at least one substrate A and a latent-reactive adhesive film, more particularly comprising two substrates A and B and a latent-reactive adhesive film, as is obtainable by the method of the invention, and more particularly in accordance with the observations above and below relating to the method or to the assembly itself.

Further provided by the invention, in particular, is an assembly of two substrates bonded adhesively to one another by means of an adhesive film, where the adhesive film is the reaction product of a dispersion composed of a thermoplastic component containing functional groups which are able to react with isocyanate, and of an isocyanate-containing component incorporated in particulate form by dispersion into the thermoplastic component, wherein a primer is present in the contact area between at least one of the bonded substrates and the adhesive film. In the assembly, primers are usually in dried form. The effect of a primer is based frequently on interaction (in this regard, see the more detailed observations in this text; for example, such interactions may also be chemical reactions) of the primer with the relevant substrate surface, with the relevant adhesive-film surface, or with the substrate surface and the adhesive-film surface. Where it is said within this specification that a primer is provided in an assembly—which in that case is generally a bonded assembly—the term “primer” also encompasses, in particular, dried primers and primers having undergone such interactions.

With the invention it is possible to improve significantly the stability of assemblies composed of a substrate A and of a latent-reactive adhesive film, or of a substrate A, a latent-reactive adhesive film, and a substrate B, after hot/humid storage. Another subject provided by the invention, therefore, is an assembly of two substrates A and B bonded adhesively to one another by means of an adhesive film, where the adhesive film is the reaction product of a dispersion composed of a thermoplastic component containing functional groups which are able to react with isocyanate, and of an isocyanate-containing component incorporated in particulate form by dispersion into the thermoplastic component, wherein the bond strength as determined by means of a tensile testing machine in a push-out test after storage of the assembly for 72 hours in an environment at 60° C. and 90% relative humidity (hot-humid storage) and subsequent storage for 1 day at 23° C. and 50% relative humidity is at least 50%, preferably at least 70%, very preferably at least 90% of the bond strength determined for an identical assembly stored, following its production, exclusively at 23° C. and 50% relative humidity, and/or the bond strength as determined by means of a tensile testing machine in a push-out test after storage of the assembly for 72 hours in an environment at 85° C. and 85% relative humidity (hot-humid storage) and subsequent storage for 1 day at 23° C. and 50% relative humidity is at least 50%, preferably at least 70%, very preferably at least 90%, of the bond strength determined for an identical assembly stored, following its production, exclusively at 23° C. and 50% relative humidity,

where the measurement has been carried out in accordance with the experiments identified in the present specification (see experimental section, test methods, “test (A)” and “test (C)”) and the results are based in particular on investigation specimens having respective adhesive areas of 91.9 mm².

Assemblies having the aforesaid hot-humid resistance properties are, in particular, those as obtainable by the method of the invention, and in particular in accordance with the observations above and below relating to the method or to the assembly itself.

With preference the assembly of the invention meets the requirements for shock resistance, as determined via the ball-drop test; see test methods, test (B). This test involves recording the height of drop at which a steel ball falling and striking the bonded assembly under defined conditions (mass 5.6 g; bond area 360 mm²) does not part the assembly. The test is considered to be passed when the assembly withstands the ball dropping from a height of at least 175 cm or more, preferably at least 200 cm or more, very preferably at least 225 cm or more.

The invention further provides an assembly of two substrates bonded adhesively to one another by means of an adhesive film, where the adhesive film is the reaction product of a dispersion of a thermoplastic component containing functional groups which are able to react with isocyanate, and of an isocyanate-containing component incorporated in particulate form into the thermoplastic component by dispersion—more particularly an assembly of the kind which exhibits the aforesaid hot-humid resistances (at 60° C./90% rh and/or at 85° C./85% rh) and/or withstands the striking of a steel ball (mass 5.6 g) from 175 cm or more in the ball-drop test and/or which is obtainable by the method of the invention—where the assembly is part of an optical, electronic and/or precision-mechanical device, more particularly of a transportable optical, electronic, or precision-mechanical device, or is used in the production of such a device.

One advantageous embodiment of the invention is an assembly particularly for use for optical, electronic and/or precision-mechanical devices, consisting of a first substrate, a second substrate, and a latent-reactive adhesive film, where
at least one substrate has inorganic (hydrophilic) character on the side to be bonded,
the latent-reactive adhesive film comprises at least one latent-reactive adhesive film layer, which contains a thermoplastic component, which has a melting temperature (as dried film) T(melt) where 35° C.≦T(melt)≦90° C. and contains functional groups which are able to react with isocyanate, and an isocyanate-containing component, which is present in particulate form, more particularly finely particulate form, in dispersion in the thermoplastic component and is blocked, microencapsulated, or substantially deactivated in the region of the particle surface, where the particles have an onset temperature T(onset) of 40° C.≦T(onset)≦120° C.,
at least one, preferably each, of the inorganic (hydrophilic) substrate surface to be bonded with the latent-reactive adhesive film, and/or the corresponding surface of the adhesive film that is contacted with this inorganic substrate surface, is provided with a primer.

This assembly meets the requirement that the bond strength of the assembly is affected to less of an extent or not at all by exposure to hot, humid conditions. The assembly has a bond strength (according to test A) before hot/humid storage (according to test C) of at least 3 N/mm². The bond strength after hot/humid storage (according to test C) is at least 50%, preferably at least 70%, very preferably at least 90%, in comparison to a reference assembly which has not undergone hot, humid storage (bond strength=100%). Furthermore, this assembly preferably also meets the requirements relating to the shock resistance (determined via the ball drop, test B) with at least 175 cm.

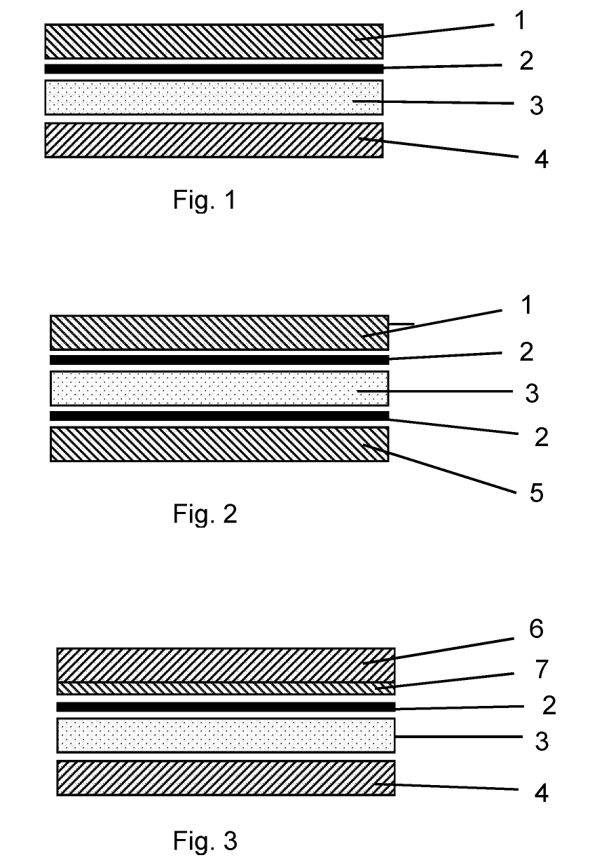

Examples of assemblies of the invention are shown in FIGS. 1, 2, and 3. The meanings of the reference numerals in these figures are as follows:
1 substrate A, more particularly inorganic material
2 primer
3 latent-reactive adhesive film
4 substrate B, particularly organic material
5 substrate B, particularly inorganic material
6 substrate A, particularly inorganic material, with
7 inorganically modified surface of the material A (6)

### Latent-Reactive Adhesive Films

The latent-reactive adhesive films comprise a thermoplastic component which has a melting temperature T(melt) and contains functional groups which are able to react with isocyanate, and also an isocyanate-containing component which is present in dispersion in particulate form, more particularly finely particulate form, in the thermoplastic component, and is blocked, microencapsulated, or substantially deactivated in the region of the particle surface. Finely particulate in this context means a particle size distribution with d₅₀<50 μm, the particle size distribution being preferably <15 μm. Latent-reactive adhesive films are based preferably on what are called 1K [1-component] latent-reactive polyurethane, obtained from aqueous polyurethane dispersion, preferably Dispercoll U® from Bayer AG; in that case the isocyanate-containing component is a component which is substantially deactivated in the region of the particle surface.

The particles have an onset temperature T(onset) for which T(melt)≦T(onset). T(melt) is between 35° C. and 90° C., preferably between 40° C. and 60° C. T(onset) is between 40° C. and 120° C., preferably not more than 100° C., very preferably not more than 90° C. As a lower limit, 50° C. is preferred and 60° C. particularly preferred. The latent-reactive adhesive films are nontacky at room temperature, so that good (re)positionability is ensured before thermal initiation takes place and the development of the strength of the adhesive bond is commenced.

With particular preference T(melt)<T(onset), since in this way it is possible reliably to avoid unwanted triggering of the crosslinking reaction during the production of the latent-reactive adhesive film in web form.

The thermoplastic component used preferably comprises compounds which have functionalization with OH and/or NH₂ groups. Very preferably the thermoplastic component is at least one semicrystalline polyesterpolyurethane.

The latent-reactive adhesive film in this case preferably comprises an anionic, high molecular mass polyurethane dispersion as thermoplastic component, which has a melting temperature (in dried form) T(melt) where 35° C.≦T(melt)≦90° C., more particularly 40° C.≦T(melt)≦60° C., and which contains functional groups which are able to react with isocyanate, in the form, for example, of commercially available products from the abovementioned Dispercoll U family, such as Dispercoll U53, Dispercoll U54, Dispercoll U56, Dispercoll U 8755, Dispercoll U XP 2815, Dispercoll VP KA 8758, Dispercoll U XP 2682, Dispercoll U 2824 XP, Dispercoll U XP 2701, Dispercoll U XP 2702, Dispercoll U XP 2710 and/or Dispercoll BL XP 2578 (Dispercoll is a registered trademark of Bayer AG).

Moreover, the latent-reactive adhesive film preferably comprises tolylene diisocyanate compounds (TDI compounds), such as Dispercoll BL XP 2514 (TDI dimer) and/or Aqualink U (dispersion of blocked TDI dimer), and/or isophorone diisocyanates (IPDI), such as Aqualink D (dispersion of blocked IPDI trimer), as isocyanate-containing component, which is present in dispersion in particulate form, more particularly finely particulate form, in the thermoplastic component and is blocked, microencapsulated, or substantially deactivated in the region of the particle surface. The diisocyanates are used, for example, in the form of the aqueous suspensions of the particular latent-reactive solid-state isocyanate. Aqualink is available from Aquaspersions. Particularly in combination with anionic, high molecular mass polyurethane dispersions as thermoplastic component (such as the stated Dispercoll U products), the aforementioned diisocyanate products can be used as a crosslinker component. Other isocyanates can be used, including monomeric and oligomeric compounds and also polyisocyanates.

The latent-reactive adhesive film may further comprise other formulation constituents. These include thickeners, wetting agents, defoamers, fillers (e.g., thermally conducting fillers), pigments (including agents for coloring, for adjusting whiteness and/or for blackening), catalysts, stabilizers, aging inhibitors, light stabilizers, and further polymers for establishing specific adhesive properties. Specific adhesive properties may be established, for example, by admixing of aqueous dispersions of amorphous polymers (e.g., polyetherurethanes or polyacrylates) and/or by admixing of aqueous resin dispersions (especially those based on rosin esters) or liquid resins.

In the assembly of the invention, a latent-reactive adhesive film having at least one layer of a latent-reactive adhesive formulation is employed, with a layer thickness of between at least 10 μm and at most 500 μm, preferably between at least 20 μm and at most 250 μm.

The latent-reactive adhesive films are double-sidedly adhesive products. Such products, comprising at least one latent-reactive adhesive film layer, are employed at their most simple in one-layer form (so that the latent-reactive adhesive film layer and the latent-reactive adhesive film are identical), applied to a redetachable (temporary) carrier material. Suitable temporary carrier material includes all release films and release papers which are known from the prior art and are furnished from one or both sides with a release layer. Siliconized papers are preferred. Papers may also be coated on one or both sides with polyethylene or polypropylene. It is also possible to employ two plies of a redetachable carrier material, so that top face and bottom face of the adhesive film are lined, even if the product is not in a wound form. A temporary carrier material is not part of the bonded assembly. It is removed from the latent-reactive adhesive film before the substrates are bonded.

Latent-reactive adhesive films comprising at least one latent-reactive adhesive film layer may further comprise an additional carrier material, which is part of the assembly even after bonding (permanent carrier). For this purpose, films and papers are likewise appropriate, as are also laid scrims, woven fabrics, and knitted fabrics. The surfaces of these carrier materials may have been pretreated, in each case independently of one another, chemically (primer, plasma) and/or physically (corona, flame, plasma) in such a way that particularly effective anchoring of the latent-reactive adhesive film layer on the carrier material can be achieved. Nonwoven webs are preferred. A ply of a permanent carrier reduces any tendency of the adhesive film layer to be squeezed out from the side of the bondline in the melted state under pressing conditions (in this regard see DE 10 2009 006 935 A1).

Sheetlike structures made from individual fibers are used as carrier nonwoven web in this preferred case. It is possible here to use all of the nonwoven webs defined according to the DIN EN 29092 standard. The web consists of fibers loosely laid together which as yet are not joined to one another. The strength results from the adhesion inherent in the fiber. Differentiation is also made between consolidated and unconsolidated webs. The fibers are randomly distributed. The webs can be differentiated according to the fiber materials. Fiber materials which can be used are mineral fibers, such as glass, mineral wool or basalt, for example, animal fibers, such as silk or wool, for example, plant fibers, such as cotton, cellulose, for example, manmade fibers, such as polyamide, polypropylene, polyphenylene sulfide, polyacrylonitrile, polyimide, polytetrafluoroethylene, aramid or polyester, for example, or mixtures of the aforesaid substances. The fibers may be consolidated mechanically by needling or waterjets, chemically by addition of binders, or thermally by softening in a suitable gas stream, between heated rolls, or else in a flow of steam.

One very preferred version of the invention uses cellulose-based nonwoven webs. The basis weight of the webs is preferably between 4 and 100 g/m², more preferably between 10 and 70 g/m². Such webs are available commercially, for example, from Glatfelter. The thickness of these webs is preferably between 20 and 100 μm, most preferably between 30 and 60 μm.

Latent-reactive adhesive films with permanent carrier may, on the top and bottom faces, have latent-reactive adhesive film layers differing in thickness and/or, preferably, latent-reactive adhesive film layers differing in type. Where different latent-reactive adhesive film layers are employed, both layers, in particular, meet the above-stated requirements concerning the latent-reactive adhesive formulations.

Latent-reactive adhesive films comprising at least one latent-reactive adhesive film layer may also be employed in two-layer or multilayer form without a permanent carrier. The uppermost layer, preferably, and very preferably the lowermost layer as well, are each a layer of latent-reactive adhesive formulation, and may differ in thickness and/or type. Where different latent-reactive adhesive film layers are employed, then, in particular, both layers meet the above-stated requirements with regard to the latent-reactive adhesive formulations.

In the case of multilayer latent-reactive adhesive films with or without permanent carrier, the possible embodiments include in principle those which have the latent-reactive adhesive film layer on the top face and, on the bottom face, a layer of a different adhesive, such as a pressure-sensitive adhesive or a hotmelt adhesive, for example.

Multilayer latent-reactive adhesive films containing permanent carriers may have thicknesses of 50 μm to 1000 μm, preferably of 75 μm to 300 μm.

The latent-reactive adhesive film may be in web form as roll product, as sheet product or as diecuts and may be utilized in this way to construct the assembly. The latent-reactive adhesive films are preferably nontacky at room temperature, since in this form the material can be very advantageously converted even without a temporary carrier (by diecutting, for example) and provided for the further-processing operation. A tacky embodiment, however, is also conceivable and advantageous.

### Substrates to be Bonded

In the assembly of the invention, in particular two substrates (substrate A and substrate B) are bonded to one another by means of a latent-reactive adhesive film as defined above. The invention is particularly suitable in the event that at least substrate A, possibly also substrate B, have an inorganic (hydrophilic) character to the surface provided with the latent-reactive adhesive film, and more particularly are provided with a primer.

In the method of the invention, two substrates (substrate A and substrate B) are bonded, in particular by means of a latent-reactive adhesive film, as is described in more detail within this specification.

At least substrate A and possibly also substrate B have an inorganic (hydrophilic) character on the surface to be provided with the latent-reactive adhesive film, and are provided with a primer, before the surface is provided with the latent-reactive film. In the case of pretreatment of the substrate to be bonded, by application of primer, the target surface is modified in a targeted way with the maximum possible efficiency of the active substance. Alternatively or additionally, one or both of the surfaces of the latent-reactive adhesive film may also have been provided with a primer.

### Substrates A

For window and display applications in electronic and mobile devices, glasses are increasingly being employed as substrates A. They may be made, for example, from mineral glass, quartz glass or sapphire glass. Through various modifications the optical and also physical properties of the glasses may be influenced in a targeted way. For decorative reasons, for example, smoked glasses or colored glasses are used. With surface coatings or finishes, which may be applied, for example, by spray application or via a vapor deposition process, the visual appearance can likewise be influenced in a targeted way. Also commonplace are antireflection layers, scratch resistance coatings, and other functional surface coatings. In their most simple form the glasses are present as flat glass, but can also be molded to form three-dimensional windows or components.

Other materials to be bonded for substrates A may be metallic or may have a metallic surface. Such metallic components may generally be made of all common metals and metal alloys.

Employed with preference are metals, such as, for example, aluminum, stainless steel, steel, magnesium, zinc, nickel, brass, copper, titanium, ferrous metals, and austenitic alloys. Additizations and alloys of any kind are likewise common. The components may also be constructed in multi-ply form from different metals. For optical reasons and to improve the surface properties and surface quality, surface modifications are frequently performed on the metal components. Thus, for example, brushed aluminum and brushed stainless steel components are frequently employed. Forms of metallization include not only chroming but also coatings with, for example, gold or silver for passivation. The metal parts may have any of a very wide variety of shapes and sizes, and may be flat or three-dimensional in form. Moreover, the functions may also be very different, and range from decorative elements to stiffening supports, frame components, covers, etc.

For aluminum and magnesium, anodizing (eloxing) is common, and is frequently combined with coloring operations. In that case the surface to be bonded has a ceramic character.

Materials for substrates A may, furthermore, be materials which are not inorganic, and which are therefore organic, such as plastics, with inorganic (hydrophilic) modification on the surface bonded or to be bonded to the latent-reactive adhesive film. Where the material of substrate A comprises plastic, the plastics parts for consumer electronics components or other mobile devices are based preferably on plastics which can be processed by injection molding. Hence this group embraces, for example, ABS, PC, ABS/PC blends, PMMA, polyamides, glass fiber-reinforced polyamides, polyvinyl chloride, polyvinylene fluoride, cellulose acetate, cycloolefin copolymers, liquid-crystal polymers (LCP), polylactide, polyetherketones, polyetherimide, polyethersulfone, polymethylmethacrylimide, polymethylpentene, polyphenylether, polyphenylene sulfide, polyphthalamide, polyurethanes, polyvinyl acetate, styrene-acrylonitrile copolymers, polyacrylates or polymethacrylates, polyoxymethylene, acrylate-styrene-acrylonitrile copolymers, polyethylene, polystyrene, polypropylene, or polyesters (e.g. PBT, PET). The listing makes no claim to completeness. Very preferably the plastics used are polycarbonate, polyamide, PMMA, or ABS. The surface modification in these cases features a coating with inorganic (hydrophilic) material such as, for example, metal or ceramic (especially oxides or layers produced by sol/gel methods). Common such surface modifications are surface coatings applied by physical vapor deposition (PVD) or chemical vapor deposition (CVD).

### Substrates B

Substrates B may be subject to the same definitions as stated for substrates A. The surface of substrate B that is to be bonded with the latent-reactive adhesive film, however, may also have a noninorganic (hydrophilic) character, thus being possibly of organic nature, such as made of plastic, for example. Where the material of substrate B comprises plastic, the plastics parts for consumer electronics components or other mobile devices are based preferably on plastics which can be processed by injection molding. Hence this group embraces, for example, ABS, PC, ABS/PC blends, PMMA, polyamides, glass fiber-reinforced polyamides, polyvinyl chloride, polyvinylene fluoride, cellulose acetate, cycloolefin copolymers, liquid-crystal polymers (LCP), polylactide, polyetherketones, polyetherimide, polyethersulfone, polymethylmethacrylimide, polymethylpentene, polyphenylether, polyphenylene sulfide, polyphthalamide, polyurethanes, polyvinyl acetate, styrene-acrylonitrile copolymers, polyacrylates or polymethacrylates, polyoxymethylene, acrylate-styrene-acrylonitrile copolymers, polyethylene, polystyrene, polypropylene, or polyesters (e.g. PBT, PET). The listing makes no claim to completeness. The components may adopt any desired form required for the production of a component or housing for consumer electronics articles. In their simplest form they are planar. Furthermore, however, three-dimensional components are also entirely customary. The components may have any of a wide variety of functions, such as housing, viewing window or reinforcing element, for example. Very preferably the plastics used are polycarbonate, polyamide, PMMA, or ABS.

The components for substrates B, more particularly plastics parts, may have been coated with surface-coating materials or otherwise. Surface-coating materials used for surface functionalization/modification of plastics, as well as other substrates, are, for example, antireflection coatings, antifingerprint coatings, antiscratch coatings, or decorative prints (referred to as backprints). Furthermore, the components, especially the plastics components, may also have been provided with (inorganic) layers, such as conductive layers, for example. One particular such conductive layer is indium tin oxide. These surface-coating materials and layers in some cases are heat-sensitive and therefore already necessitate, of themselves, the use of adhesive products which can be processed at low temperature.

The components, whether they be of glass, metal, ceramic, or plastic with inorganic (hydrophilic) surface, may take on any desired form which is necessary for the production of a component or housing for consumer electronics articles. In their simplest form they are planar. Furthermore, however, three-dimensional components are also entirely customary. The components may have any of a wide variety of functions, such as housing, viewing window or reinforcing element, for example.

### Primer

Employed for the purposes of this invention is a primer which leads to significant stabilization of the assembly strength under hot/humid conditions. Assemblies of the invention have, in particular, at least one substrate which, on the surface provided with the latent-reactive adhesive film, as described within this specification, has an inorganic (hydrophilic) surface. This surface and/or the adhesive-film surface contacted or to be contacted with this surface is provided with the primer. In the case of the methods of the invention for bonding two substrates with a latent-reactive adhesive film of the invention, where at least one of the substrates has an inorganic (hydrophilic) surface on the side to be bonded, the at least one inorganic (hydrophilic) surface to be bonded is provided with the primer, and/or the adhesive film surface contacted or to be contacted therewith is provided with the primer and optionally dried before bonding with the latent-reactive adhesive film is performed. The primer very preferably comprises at least one silane.

In a further-preferred procedure, at least one surface of the latent-reactive adhesive film is provided with a primer and optionally dried before the substrates are bonded to one another. Two classes of silanes may be distinguished for the very preferred silane-based primers for the purposes of this invention: firstly, those which in addition to the groups capable of reaction with the inorganic (hydrophilic) substrate surface carry exclusively organic radicals which are chemically inert (see structure I); secondly, those which in addition to the groups capable of reaction with the inorganic (hydrophilic) substrate surface include at least one organic radical which carries at least one group X which is able to enter into a compound with at least one functional group which is present in the formulation of the latent-reactive adhesive film according to the above definition (see structure II). The primer preferably comprises at least one silane in structure II. In silanes of structure I, at least one of the substituents A, B, and D represents a hydrolyzable group, in other words, for example, a chlorine atom or, in particular, an alkoxy group. At least one of the substituents B, C, and D represents an organic radical which consists of a linear, branched or cyclic hydrocarbon, which may also be aromatic and which is of low molecular mass, oligomeric or polymeric in nature. Where there is more than one hydrolyzable group among the substituents A, B, and D, they may be identical or different in chemical nature, with all of them meeting the above definition of hydrolyzable groups. Where there is more than one organic radical among the substituents B, C, and D, they may likewise be identical or different in chemical nature, with all of them meeting the above definition of organic radicals.

In silanes of structure II, at least one of the substituents A, E, and F is a hydrolyzable group, in other words, for example, a chlorine atom or, in particular, an alkoxy group. At least one of the substituents E, F, and G is an organic radical which consists of a linear, branched or cyclic hydrocarbon, which may also be aromatic and is low molecular mass, oligomeric or polymeric in nature, and which additionally contains at least one group X which is able to enter into a compound with at least one functional group which is present in the formulation of the latent-reactive adhesive film according to the definition above. Where there is more than one hydrolyzable group among the substituents A, E, and F, they may be identical or different in chemical nature. Where there is more than one organic radical among the substituents E, F, and G, they may likewise be identical or different in chemical nature, with all of them meeting the above definition of organic radicals.

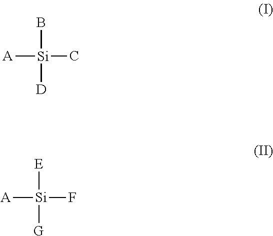

Advantageous versions of silanes of structure I which can be used in accordance with the invention are those for which only A is employed as hydrolyzable group, and for which B, C, and D are organic radicals of which B and D are the same in chemical nature and B is different in chemical nature. Further advantageous embodiments of silanes of structure I which can be employed in accordance with the invention are those in which A and B are employed as hydrolyzable groups of identical chemical nature, and C and D are organic radicals which are identical in chemical nature. Further advantageous embodiments of silanes of structure I which can be used in accordance with the invention are those for which A, B, and D are employed as hydrolyzable groups of identical chemical nature, and C is an organic radical.

Advantageous embodiments of silanes of structure II which can be used in accordance with the invention are those for which only A is employed as hydrolyzable group, and E, F, and G are organic radicals, of which E and F are identical in chemical nature and G is different in chemical nature. G contains the at least one group X which is able to enter into a compound with at least one functional group which is present in the formulation of the latent-reactive adhesive film according to the definition above. Further advantageous embodiments of silanes of structure II which can be used in accordance with the invention are those for which A, E, and F are employed as hydrolyzable groups of identical chemical nature, and G is an organic radical which contains the at least one group X which is able to enter into a compound with at least one functional group which is present in the formulation of the latent-reactive adhesive film according to the definition above.

Hydrolyzable groups A, B, D, E, and F which may be employed advantageously in silanes I and silanes II are halogen atoms, especially chlorine, and/or, and very preferably exclusively, alkoxy groups, such as, for example, methoxy, ethoxy, n-propoxy, isopropoxy, n-butoxy, sec-butoxy or tert-butoxy groups. Acetoxy groups can additionally be employed. The other examples of hydrolyzable groups that are known to the skilled person may likewise be employed for the purposes of this invention.

The organic radicals B, C, D, E, and F which may be employed in silanes I and silanes II include for example, without any claim to completeness, methyl, ethyl, n-propyl, isopropyl, n-butyl, sec-butyl, and tert-butyl groups, pentyl groups and also the branched isomers, hexyl groups and also the branched isomers, heptyl groups and also the branched isomers, octyl groups and also the branched isomers, nonyl groups and also the branched isomers, decyl groups and also the branched isomers, undecyl groups and also the branched isomers, dodecyl groups and also the branched isomers, tetradecyl groups and also the branched isomers, hexadecyl groups and also the branched isomers, octadecyl groups and also the branched isomers, and eicosyl groups and also the branched isomers. The organic radicals of the invention may, moreover, contain annular and/or aromatic components. Representative structures are cyclohexyl, phenyl, and benzyl groups. It is further in accordance with the invention if oligomers or polymers which contain at least one hydrolyzable silyl group are employed as at least one organic radical.

The organic radicals E, F, and G which contain at least one group X which is able to enter into a compound with at least one functional group present in the formulation of the latent-reactive adhesive film according to the definition above include, for example, the compounds compiled in the following list (the list makes no claim to completeness): methyl, ethyl, n-propyl, isopropyl, n-butyl, sec-butyl, and tert-butyl groups, pentyl groups and also the branched isomers, hexyl groups and also the branched isomers, heptyl groups and also the branched isomers, octyl groups and also the branched isomers, nonyl groups and also the branched isomers, decyl groups and also the branched isomers, undecyl groups and also the branched isomers, dodecyl groups and also the branched isomers, tetradecyl groups and also the branched isomers, hexadecyl groups and also the branched isomers, octadecyl groups and also the branched isomers, and eicosyl groups and also the branched isomers. The organic radicals of the invention may, moreover, contain annular and/or aromatic components. Representative structures are cyclohexyl, phenyl, and benzyl groups. It is further in accordance with the invention if oligomers or polymers which contain at least one hydrolyzable silyl group are employed as at least one organic radical. Where one or more of the radicals E, F, and G employed is or are a radical from the list above, it is additionally modified by a chemical component which contains at least one group X.

Examples of silanes having structure I that can be employed with preference for the purposes of this invention are methyltrimethoxysilane, methyltriethoxysilane, dimethyldimethoxysilane, dimethyldiethoxysilane, trimethylethoxysilane, ethyltrimethoxysilane, propyltrimethoxysilane, propyltriethoxysilane, isobutyltrimethoxysilane, isobutyltriethoxysilane, octyltrimethoxysilane, octyltriethoxysilane, isooctyltrimethoxysilane, isooctyltriethoxysilane, hexadecyltrimethoxysilane, hexadecyltriethoxysilane, octadecylmethyldimethoxysilane, phenyltrimethoxysilane, phenyltriethoxysilane, cyclohexylmethyldimethoxysilane, dicyclopentyldimethoxysilane, vinyltrimethoxysilane, vinyltriethoxysilane, vinyltri(2-methoxyethoxy)silane, vinyltriisopropoxysilane, vinyldimethoxymethylsilane, and vinyltriacetoxysilane.

An example of silyl-functionalized oligomers or polymers which may be employed in accordance with the invention is polyethylene glycol linked to a trimethoxysilane group.

Representatives of the silanes of structure II that can be employed with particular preference for the purposes of this invention and that carry at least one functionalization are, for example, N-(2-aminoethyl)-3-aminopropyltrimethoxysilane, N-(2-aminoethyl)-3-aminopropyltriethoxysilane, 3-aminopropyltrimethoxysilane, 3-aminopropyltriethoxysilane, 3-aminopropyldiethoxymethylsilane, N-(2-aminoethyl)-3-aminopropyldimethoxymethylsilane, (N-butyl)-3-aminopropyltrimethoxysilane, 3-(N-ethylamino)-2-methylpropyltrimethoxysilane, 4-amino-3,3-dimethylbutyltrimethoxysilane, 4-amino-3,3-dimethylbutyldimethoxymethylsilane, (N-cyclohexyl)aminomethyldimethoxymethylsilane, (N-cyclohexyl)aminomethyltrimethoxysilane, (N-phenyl)-3-aminopropyltrimethoxysilane, (N-phenyl)aminomethyldimethoxymethylsilane, (N-benzyl-2-aminoethyl)-3-aminopropyltrimethoxysilane, [2-(N-benzyl-N-vinylamino)ethyl]-3-aminopropyltrimethoxysilane hydrogenchloride, [2-(N-benzyl-N-vinylamino)ethyl]-3-aminopropyltrimethoxysilane, bis(3-propyltriethoxysilyl)amine, 3-triethoxysilylpropylsuccinic anhydride, 3-glycidyloxypropyltrimethoxysilane, 3-glycidyloxypropyltriethoxysilane, 2-(3,4-epoxycyclohexyl)ethyltriethoxysilane, 3-glycidyloxypropyldiethoxymethylsilane, 3-isocyanatopropyltrimethoxysilane, 3-isocyanatopropyltriethoxysilane, isocyanatomethyltrimethoxysilane, isocyanatomethyldimethoxymethylsilane, tris[3-(trimethoxysilyl)propyl]isocyanurate, 3-ureidopropyltrimethoxysilane, 3-ureidopropyltriethoxysilane, 3-mercaptopropyltrimethoxysilane, 3-mercaptopropyldimethoxymethylsilane, bis(3-triethoxysilylpropyl)disulfane, bis(3-triethoxysilylpropyl)tetrasulfane, bis(triethoxysilylpropyl)polysulfane, octadecylaminodimethyltrimethoxysilylpropylammonium chloride.

Other constituents of primers include film formers such as polymers, rheological additives, stabilizers, catalysts and/or other agents for establishing a desired pH. Primers are preferably in the form of solutions or dispersions in organic solvents and/or water. Preferred are mixtures of alkyl alcohols and water.

### Method for Producing Assemblies of the Invention

The method of the invention has already been set out above.

In one advantageous embodiment of the method of the invention, two substrates are bonded with a latent-reactive adhesive film, where
at least one substrate has inorganic (hydrophilic) character on the side to be bonded,
each inorganic (hydrophilic) substrate surface to be bonded with the latent-reactive adhesive film is provided with a primer,
the primer is optionally dried,
the latent-reactive adhesive film comprises at least one latent-reactive adhesive film layer which contains a thermoplastic component, which has a melting temperature (as dried film) T(melt) where 35° C.≦T(melt)≦90° C. and contains functional groups which are able to react with isocyanate, and an isocyanate-containing component, which is present in dispersion in particulate form, more particularly finely particulate form, in the thermoplastic component and is blocked, microencapsulated, or substantially deactivated in the region of the particle surface, where the particles have an onset temperature T(onset) of 40° C.≦T(onset)≦120° C.,
the latent-reactive adhesive film either is first applied to one of the two substrates and then contacted with the other substrate, or is contacted with both substrates simultaneously,
   before the bonding reaction is effected by heating to a temperature at least at the level of the onset temperature.

A further aspect of the invention relates to a method for adhering two substrates with a latent-reactive adhesive film, where
at least one substrate has inorganic (hydrophilic) character on the side to be bonded,
the latent-reactive adhesive film comprises at least one latent-reactive adhesive film layer which contains a thermoplastic component, which has a melting temperature (as dried film) T(melt) where 35° C.≦T(melt)≦90° C. and contains functional groups which are able to react with isocyanate, and an isocyanate-containing component, which is present in dispersion in particulate form, more particularly finely particulate form, in the thermoplastic component and is blocked, microencapsulated, or substantially deactivated in the region of the particle surface, where the particles have an onset temperature T(onset) of 40° C.≦T(onset)≦120° C.,
at least the side that is to be contacted with the substrate having the surface with the inorganic (hydrophilic) character, or both sides of the latent-reactive adhesive film, is or are provided with a primer,
the primer is optionally dried,
and the primed, latent-reactive adhesive film either is first applied to one of the two substrates and then contacted with the other substrate, or is contacted with both substrates simultaneously,
   before the bonding reaction is effected by heating to a temperature at least at the level of the onset temperature.

The resulting assembly, especially for use for optical, electronic and/or precision-mechanical devices, has a bond strength (according to test A) before hot/humid storage (according to test C) of at least 3 N/mm². The bond strength of the resulting assembly after hot/humid storage (according to test C) is at least 50%, preferably at least 70%, very preferably at least 90%, in comparison to the reference assembly which has not undergone hot, humid storage (bond strength=100%). Furthermore, the resulting assembly preferably also meets the requirements relating to the shock resistance (determined via the ball drop, test B) with at least 175 cm.

For production of composites for mobile devices, given as an example, an application in consumer electronics articles may be addressed here. In this example production method, first of all each substrate having inorganic (hydrophilic) character on the surface to be bonded is provided with a primer. The primer is applied manually (by brushing or spraying, for example) or mechanically (by coating or printing, for example). Where the primer contains solvents and/or water, application is followed by drying. The thickness of the primer after drying is preferably less than 10 μm, preferably less than 5 μm, very preferably less than 2 μm, or, even, less than 1 μm.

If a surface of the latent-reactive adhesive film is provided with primer, then the primer is applied manually (by brushing or spraying, for example) or mechanically (by coating or printing, for example). Application may take place over a partial area or the full area. Where the primer contains solvents and/or water, application is followed by drying. The thickness of the primer after drying is preferably less than 10 μm, preferably less than 5 μm, very preferably less than 2 μm, or, even, less than 1 μm.

The latent-reactive adhesive films are customarily processed to diecuts from roll product and provided in diecut form for production of assemblies. The diecuts are produced either by a laser cutting process, by flat-bed diecutting or by rotary diecutting. The diecut customarily has the dimensions of the first component, but may also be somewhat smaller, in order to permit easy squeeze-out operations during the adhesive bonding operation.

In the simplest case, the diecut of the latent-reactive adhesive film without temporary carrier is positioned manually, with the aid of tweezers, for example, on the first component, or between the components to be assembled.

In another embodiment, the diecut of the latent-reactive adhesive film, after positioning on the first component, is treated with a heat source, thereby raising the adhesion of the diecut to the first component. In the simplest case, the heat source used may be an IR lamp, an iron, or a hotplate. For this operation it is advantageous if the diecut is further equipped with a temporary carrier material, in order to prevent the adhesive film sticking to the tooling or to the heat source.

In a further advantageous embodiment, the first component is placed onto the diecut of the latent-reactive adhesive film. Placement takes place on the open side. On the reverse side there is still the temporary carrier material. Thereafter, a heat source introduces heat through the first component in the latent-reactive adhesive film. This makes the adhesive film tacky, i.e., sticky, and it adheres more strongly to the first component than to the temporary carrier. It is heated through the first component.

In one preferred version, a heating press is used to introduce the heat. The die of the heating press in this case is manufactured of aluminum, brass or bronze, for example, and is shaped to conform in general to the contours of the component and/or the dimensions of the diecut. In order to ensure precise positioning of the diecut on the first component, shaping parts are generally used that are adapted to the contours of the components to be bonded, thereby preventing instances of slippage. Guide pins in the shaping part and corresponding guide holes in the temporary carrier material of the latent-reactive adhesive film allow precise positioning to be ensured between diecut and first component. Other positioning facilities are conceivable. Following heat activation, the first component is removed from the shaping part, with the adhesive film laminated to it. The entire operation may also be converted to an automatic process.

The method for producing an assembly of the invention therefore also relates to the sub-operation comprising the following steps:
a) fixing the first component on a shaping component;
b) placing the second component to be bonded, with a double-sided, latent-reactive adhesive film having at least one latent-reactive adhesive film layer which contains a thermoplastic component, which has a melting temperature T(melt) where 35° C.≦T(melt)≦90° C. and contains functional groups which are able to react with isocyanate, and an isocyanate-containing component, which is present in dispersion in particulate form, more particularly finely particulate form, in the thermoplastic component and is blocked, microencapsulated, or substantially deactivated in the region of the particle surface, where the particles have an onset temperature T(onset) of 40° C.≦T(onset)≦120° C. and where T(onset)≧T(melt), on the second component;
c) applying pressure and temperature, in particular by means of a heating press die;
d) removing the bonded assembly from the shaping component,
   where alternatively cooling may also be carried out between step c) and step d), and where one or all of the component surfaces to be bonded that have inorganic (hydrophilic) character on the relevant surface, and/or one or both surfaces of the latent-reactive adhesive film before step b), are provided with primer, more particularly such that primer is provided at least on all contact area for which one of the surfaces forming it has inorganic (hydrophilic) character.

In step c), pressure and temperature are applied. This is done by a heating die which consists of a material having good thermal conductivity. Examples of advantageous materials are copper, brass, bronze, or aluminum. Other metals or alloys can also be used, however. Furthermore, the heating press die ought preferably to adopt the shape of the top face of one component. This shape may in turn be 2-dimensional or 3-dimensional in nature. The pressure is applied advantageously via a pneumatic cylinder. Application, however, need not necessarily take place via air pressure. Also possible, for example, are hydraulic pressing devices or electromechanical actuating drives, via spindles, for example. It may be an advantage, moreover, to introduce pressure and temperature a multiplicity of times, in order to increase the operational throughput by means of series connection or rotational principle, for example. The heating press dies in that case need not all be operated at the same temperature and/or same pressure. Furthermore, the contact times of the dies may also be varied. Preferred contact times are at most 600 s, very preferably less than 300 s, more preferably less than 150 s. Pressing pressures are preferably less than 6 bar, very preferably less than 4 bar. Heating die temperatures are preferably less than 150° C., very preferably less than 125° C., and more preferably less than 100° C.

Assemblies of the invention meet requirements (i) and (iii), preferably requirements (i), (ii), and (iii), of the following list:
(i) push-out strength before hot/humid storage (test A) ≧3 N/mm², preferably ≧4 N/mm², very preferably ≧5 N/mm²
(ii) push-out strength after hot/humid storage in comparison to the reference not given hot/humid treatment (=100%) (test C): ≧50%, preferably ≧70%, very preferably ≧90%
(iii) shock resistance, ball drop (test B) ≧175 cm, preferably ≧200 cm, very preferably ≧225 cm.

### Test Methods

### Test (A) Push-Out:

The push-out test provides information on the bond strength of a double-sidedly adhesive product in the direction normal to the adhesive layer. A circular substrate S1 of diameter 21 mm is bonded to a frame (substrate S2) with the adhesive film under investigation, which is diecut or trimmed to a round shape, at which point it likewise has a diameter of 21 mm. The frame (substrate S2) has a circular hole of diameter 9 mm, which is substantially concentric with the substrate S1. The format of the frame (substrate S2) exceeds the format of substrate S1, so that the assembly can be placed on a tabletop by means of the protruding regions of the frame (substrate S2).

A cylindrical plunger (diameter 7 mm), which is clamped into a tensile testing machine, applies pressure perpendicularly on substrate S1 through the hole in substrate S2, by means of a constant advancing movement of the plunger, and so exerts a force on the bonded joint in the assembly. The test velocity of the plunger is 10 mm/s. A record is made of the force at which substrate S1 is detached from the frame (substrate S2). The force is related to the plunger surface area, resulting in push-out strengths in units of N/mm². The assembly passes the measurement when the push-out strength is more than 3 N/mm². The test conditions are 23° C. and 50% relative humidity.

### Test (B) Ball Drop:

This test provides information on the shock resistance or impact resistance of the test specimens bonded with the latent-reactive adhesive film, which are attributable to the shock-absorbing capacity of the adhesive film.

A square, frame-shaped sample is cut out of the latent-reactive adhesive film under investigation (external dimensions 33 mm×33 mm; border width 3.0 mm; internal dimensions (window opening) 27 mm×27 mm). This sample is bonded to a frame made of anodized aluminum (external dimensions 50 mm×50 mm; border width 12.5 mm; internal dimensions (window opening) 25 mm×25 mm; thickness 3 mm; substrate A for the purposes of the invention). On the other side of the latent-reactive adhesive film, a PC window of 35 mm×35 mm (substrate B for the purposes of the invention) is adhered. The adhesive bonding of the anodized aluminum frame, the latent-reactive adhesive-film frame, and the PC window is accomplished in such a way that the geometric centers and the diagonals lie on top of one another in each case (corner to corner). The bond area is 360 mm². The bond is pressed at 3 bar and 100° C. for 60 s and is stored for 24 hours under conditions at 23° C./50% relative humidity.

Immediately after storage, the adhesive assembly comprising the anodized aluminum frame, the latent-reactive adhesive film, and the PC sheet is placed by the protruding edges of the anodized aluminum frame onto a frame structure (sample holder) in such a way that the assembly is oriented horizontally and the PC sheet points downward, hanging freely. A steel ball (diameter 15 mm, mass 5.6 g) is dropped perpendicularly, centered on the PC sheet, onto the sample arranged in this way from a height of up to 250 cm (through the window in the anodized aluminum frame) (measuring conditions 23° C., 50% relative humidity). Three investigations are carried out with each sample, unless the PC sheet has become detached beforehand. A record is made of the drop height at which the bonded assembly has not yet detached. The greater the drop height, the higher the shock resistance.

### Test (C) Push-Out After Hot/Humid Storage:

The push-out test (C) takes place according to the stipulations from test A. The assembly under measurement, however, is stored for 72 h prior to the measurement in a conditioning cabinet, at 60° C. and 90% relative humidity in a first variant of the test method, and at 85° C. and 85% relative humidity in a second variant of the test method. Following storage and before measurement, the assemblies are reconditioned for 1 day at 23° C. and 50% relative humidity. The push-out value for assemblies having undergone hot/humid storage is placed in relation to the push-out value for an identical assembly which, following its production, has not been exposed to hot-humid influence but is instead stored exclusively at 23° C. and 50% relative humidity and measured according to test A.

The integrity of the bond strength relative to hot-humid conditions is then expressed as a percentage of the reference value. Assemblies of the invention have a resilience of at least 50%, preferably at least 70%, very preferably at least 90%.

### EXPERIMENTS

Production of a latent-reactive adhesive film: A latent-reactive adhesive film was produced from 100 parts of Dispercoll U XP 2702, 13 parts of Dispercoll BL XP 2514, and 1.5 parts of Borchigel 0625 (see above in each case). The formulation constituents were mixed as an aqueous dispersion in a beaker, using an anchor stirrer at 60 1/min, over a period of 15 min at room temperature. The solids content was adjusted to 46 wt % by addition of demineralized water. Using a laboratory coater, a coating on double-sidedly polyethylene-coated and siliconized paper was produced with a doctor blade. Resultant swatch specimens were first vented at room temperature for 30 minutes and then dried in a forced-air drying cabinet at 45° C. for 20 min. The specimens had a layer thickness of 100 μm. Sections of these specimens were used as latent-reactive adhesive films for producing assemblies for the further measurements. Prior to measurement, the specimens were stored at 23° C. and 50% relative humidity.

Two assemblies were investigated. In assembly 1, substrate S1 was polycarbonate (Macrolon 099; corresponding to substrate B as per the invention) and substrate S2 was anodized aluminum (E6EV1; corresponding to substrate A as per the invention).

In assembly 2, substrate S1 was glass (float glass; corresponding to substrate A as per the invention) and substrate S2 was polyamide (polyamide 6, 20% glass fibers; corresponding to substrate B as per the invention).

Application of the primer: The primer solution was applied uniformly with a brush to the respective surface of substrate A (anodized aluminum in assembly 1; glass in assembly 2). Thereafter the treated substrates were stored in a forced-air drying cabinet at 25° C. for 10 min in order for the surface to dry off and to allow the primer to take effect.

Two primer variants were employed. Primer P1 consisted of 0.5 g of (3-glycidyloxypropyl)trimethoxysilane (Sigma Aldrich), a silane of structure II, in a mixture of 49.5 g of isopropanol and 50 g of water. Primer P2 consisted of 1 g of (3-aminopropyl)triethoxysilane (Sigma Aldrich), a silane of structure II, and 1 g of octyltriethoxysilane (Sigma Aldrich), a silane of structure I, in a mixture of 48 g of ethanol and 50 g of ethyl acetate.

Specimen preparation for test A and test C: Using a metal punch, circular adhesive-tape diecuts having a diameter of 21 mm were produced from the one-layer adhesive film. One of these diecuts in each case was placed between a substrate S1 (assembly 1: polycarbonate; assembly 2: glass) and a substrate S2 (assembly 1: anodized aluminum; assembly 2: polyamide) and subjected to pressing in a laboratory heating press at a die temperature of 100° C. and at 3 bar for 60 s, to produce a corresponding assembly.

Specimen preparation for test B: Using a metal punch, square, frame-shaped samples (for geometry see test B) were punched out from the one-layer adhesive film. One diecut in each case was placed between a substrate S1 (assembly 1: polycarbonate) and a substrate S2 (assembly 1: anodized aluminum) and subjected to pressing in a laboratory heating press at a die temperature of 100° C. and at 3 bar for 60 s, to produce a corresponding assembly.

### Results

| | Assembly 1 | | | Assembly 2 | | |
|---|---|---|---|---|---|---|
| | S1 | Primer | S2 | S1 | Primer | S2 |
| Example 1 | Poly- | P1 | Anodized | | | |
| | carbonate | | aluminum | | | |
| Example 2 | | | | Glass | P1 | Poly- |
| | | | | | | amide |
| Example 3 | Poly- | P2 | Anodized | | | |
| | carbonate | | aluminum | | | |
| Example 4 | | | | Glass | P2 | Poly- |
| | | | | | | amide |
| Example 5 | Poly- | none | Anodized | | | |
| (comparative) | carbonate | | aluminum | | | |
| Example 6 | | | | Glass | none | Poly- |
| (comparative) | | | | | | amide |

| | | | Resilience | |
|---|---|---|---|---|
| | | | after storage | |
| | | | at 60° C./ | |
| | Push-out | Push-out | 90% rel. | Ball drop |
| | (test A) | (test C) | humidity | (test B) |
| Example 1 | 5.3 N/mm² | 5.4 N/mm² | 102% | >250 cm |
| Example 2 | 3.4 N/mm² | 3.9 N/mm² | 115% | not |
| | (glass break) | | | determined |
| Example 3 | 5.3 N/mm² | 4.2 N/mm² | 79% | >250 cm |
| Example 4 | 3.4 N/mm² | 3.2 N/mm² | 94% | not |
| | (glass break) | (glass break) | | determined |
| Example 5 | 5.3 N/mm² | 2.5 N/mm² | 47% | >250 cm |
| (comparative) | | | | |
| Example 6 | 3.4 N/mm² | 0.4 N/mm² | 12% | not |
| (comparative) | (glass break) | | | determined |

| | | | Resilience | |
|---|---|---|---|---|
| | | | after storage | |
| | | | at 85° C./ | |
| | Push-out | Push-out | 85% rel. | Ball drop |
| | (test A) | (test C) | humidity | (test B) |
| Example 1 | 5.3 N/mm² | 5.8 N/mm² | 109% | >250 cm |
| Example 2 | 3.4 N/mm² | 2.7 N/mm² | 79% | not |
| | (glass break) | (glass break) | | determined |
| Example 3 | 5.3 N/mm² | 4.8 N/mm² | 91% | >250 cm |
| Example 4 | 3.4 N/mm² | 2.8 N/mm² | 82% | not |
| | (glass break) | (glass break) | | determined |
| Example 5 | 5.3 N/mm² | 2.3 N/mm² | 43% | >250 cm |
| (comparative) | | | | |
| Example 6 | 3.4 N/mm² | 1.5 N/mm² | 44% | not |
| (comparative) | (glass break) | | | determined |

The results show that the bond strength for all test assemblies is at a high level (>3 N/mm² or even >5 N/mm²). In the case of glass as one of the substrates to be bonded, the bond strength is limited by the breaking strength of the glass substrate. Storage under hot, humid conditions results in a decrease in the bond strength unless a primer is used. When a primer is used, on the other hand, there is a reduction in the decrease in bond strength. Values of more than 100% are presumably attributable to the effect of heat during the storage under hot/humid conditions, this heat exposure being beneficial to the bond.

For test assemblies with polycarbonate, the shock resistance was additionally investigated. It was outstanding in all cases. Since glass has a tendency to shatter, test B was not conducted in these cases.

1. A method of adhering a first substrate A to a second substrate B using a latent-reactive adhesive film having at least one latent-reactive adhesive film layer which contains a thermoplastic component, which has a melting temperature T(melt) where 35° C.≦T(melt)≦90° C. and contains functional groups which are able to react with isocyanate, and an isocyanate-containing component, which is present in a particulate form incorporated by dispersion into the thermoplastic component and which is blocked, microencapsulated, or substantially deactivated in the region of the particle surface, where the particles have an onset temperature T(onset) of 40° C.≦T(onset)≦120° C. and where T(onset)≧T(melt),
where a surface of the first substrate A is contacted with a first surface of the latent-reactive adhesive film,
and where a surface of the second substrate B is contacted with the second surface of the latent-reactive adhesive film,
where the adhering is effected by heating of the latent-reactive adhesive film to a temperature which at least corresponds to the onset temperature T(onset) or is higher,
wherein at least the surface of the first substrate A that is contacted with the latent-reactive adhesive film is treated with a primer before the first substrate A is contacted with the latent-reactive adhesive film,
and/or at least the first surface of the latent-reactive adhesive film which is contacted with the first substrate A is treated with a primer before the first substrate A is contacted with the latent-reactive adhesive film.

2. The method according to claim 1, wherein:
at least the surface of the first substrate A that is contacted with a first surface of the latent-reactive adhesive film is formed wholly or partly by an inorganic material.

3. The method according to claim 2, wherein:
the surface of the first substrate B that is contacted with a second surface of the latent-reactive adhesive film is also formed wholly or partly by an inorganic material.

4. The method according to claim 1, wherein:
the surface of the second substrate B that is contacted with the latent-reactive adhesive film is treated with a primer before the second substrate B is contacted with the latent-reactive adhesive film.

5. The method according to claim 1, wherein:
the second surface of the latent-reactive adhesive film that is contacted with the second substrate B is treated with a primer before the second substrate B is contacted with the latent-reactive adhesive film.

6. The method according to claim 1, wherein:
the primer used for adhering the first substrate A to the latent-reactive adhesive film and/or the second substrate B to the latent-reactive adhesive film includes a silane.

7. The method according to claim 1, wherein:
the latent-reactive adhesive film consists of one or more of the latent-reactive adhesive film layers.

8. The method according to claim 1, wherein:
the melting temperature of the thermoplastic component is in the range 40° C.≦T(melt)≦60° C.

9. The method according to claim 1, wherein:
the onset temperature of the particles is in the range of 50° C.≦T(onset)≦120° C., preferably in the range of 60° C.≦T(onset)≦90° C.

10. The method according to claim 1, wherein:
the surface of the first substrate A is formed by a glass, a metal, or a ceramic.

11. The method according to claim 1, wherein:
the surface of the first substrate A is aluminum or anodized aluminum.

12. The method according to claim 10, wherein:
the surface of the second substrate B is formed by glass, a metal, or a ceramic.

13. The method according to claim 10, wherein:
the second substrate B is at least one of: polymethyl methacrylate, polycarbonate, acrylonitrile-butadiene-styrene copolymer (ABS), polyamide, or polycarbonate.

14. An assembly of two substrates bonded adhesively to one another, formed according to the method of claim 1.

15. An assembly of two substrates bonded adhesively to one another by means of an adhesive film, where the adhesive film is the reaction product of a dispersion composed of a thermoplastic component containing functional groups which are able to react with isocyanate, and of an isocyanate-containing component incorporated in particulate form by dispersion into the thermoplastic component,
wherein:
a primer is present in the contact area between at least one of the bonded substrates and the adhesive film.

16. The assembly according to claim 15, wherein:
the primer comprises silane.

17. The assembly according to claim 14, in which the adhesive film is the reaction product of a dispersion composed of a thermoplastic component containing functional groups which are able to react with isocyanate, and of an isocyanate-containing component incorporated in particulate form by dispersion into the thermoplastic component,
wherein:
the bond strength as determined by means of a tensile testing machine in a push-out test after storage of the assembly for 72 hours in an environment at 60° C. and 90% relative humidity (hot-humid storage) and subsequent storage for 1 day at 23° C. and 50% relative humidity is at least 50% of the bond strength determined for an identical assembly stored, following its production, exclusively at 23° C. and 50% relative humidity.

18. The assembly according to claim 14, in which the adhesive film is the reaction product of a dispersion composed of a thermoplastic component containing functional groups which are able to react with isocyanate, and of an isocyanate-containing component incorporated in particulate form by dispersion into the thermoplastic component,
wherein:
the bond strength as determined by means of a tensile testing machine in a push-out test after storage of the assembly for 72 hours in an environment at 85° C. and 85% relative humidity (hot-humid storage) and subsequent storage for 1 day at 23° C. and 50% relative humidity is at least 50% of the bond strength determined for an identical assembly stored, following its production, exclusively at 23° C. and 50% relative humidity.

19. The assembly according to claim 14, wherein the adhesive film is the reaction product of a dispersion composed of a thermoplastic component containing functional groups which are able to react with isocyanate, and of an isocyanate-containing component incorporated in particulate form by dispersion into the thermoplastic component,
wherein:
the assembly is part of an optical, electronic and/or precision-mechanical device, more particularly of a transportable optical, electronic, or precision-mechanical device.

20. The assembly according to claim 14, wherein:
at least one of the substrates is transparent or translucent.

21. The assembly according to claim 20, wherein:
the transparent or translucent substrate is a window or a lens for protecting components situated beneath it and/or for producing physico-optical effects for the function of the optical, electronic, or precision-mechanical device.

22. The assembly
according to claim 19, wherein the optical, electronic, or precision-mechanical device is selected from the group which includes:
cameras, digital cameras, photographic accessories (such as exposure meters, flashguns, diaphragms, camera casings, lenses, etc.), film cameras, video cameras, digicams, binoculars, night vision devices
computers, laptops, notebooks, netbooks, ultrabooks, tablet computers, devices with touch-sensitive screens (touchscreen devices), handhelds, electronic diaries and organizers (so-called “electronic organizers” or “personal digital assistants”, PDAs), typewriters, modems, computer accessories, such as mice, graphics pads, microphones, loudspeakers
reading devices for electronic books (“e-books”),
televisions (including mini-TVs), film players, video players, monitors, screens, displays, projectors
radios, Walkmans, music players (e.g. CD, DVD, Blu-ray, cassettes, USB, MP3 players), headphones
printers, fax machines, copiers,
telephones, mobile telephones, smartphones, two-way radios, hands-free telephones
defibrillators, blood sugar meters, blood pressure monitors
battery chargers, measuring devices, multimeters, lamps, such as torches, laser pointers, etc.
detectors, optical magnifiers, pocket calculators
remote controls, remote operating devices, games consoles
GPS devices, navigation devices
devices for summoning people (pagers, bleepers)
data storage devices (USB sticks, external hard drives, memory cards)
wrist watches, pocket watches, chain watches.

23. A method for improving the heat/humidity resistance of an adhered bond of two substrates by means of a primer treated latent-reactive adhesive film which comprises a thermoplastic component, having functional groups which are able to react with isocyanate, and an isocyanate-containing component, which is incorporated in particulate form into the thermoplastic component by dispersion and is substantially deactivated in the region of the particle surface.

24. (canceled)

25. The method of 23 used to produce an assembly of two substrates bonded adhesively to one another.
